(19) United States
(12) Patent Application Publication
(10) Pub. No.: US 2009/0192885 A1
(43) Pub. Date: Jul. 30, 2009

(54) POP method and apparatus for customer engagement

(76) Inventors: David Eimerl, Livermore, CA (US); Jack W. Moorman, Los Gatos, CA (US)

Correspondence Address: DAVID EIMERL, 4042 CAMROSE AVENUE, LIVERMORE, CA, 94551-8284, US

(21) Appl. No.: 11/986,659

(22) Filed: Nov. 26, 2007

Related U.S. Application Data
(60) Provisional application No. 60/932,986, filed on Jun. 5, 2007.

(51) Int. Cl. G06Q 30/00

(52) U.S. Cl. 705/14

(57) ABSTRACT

A method is presented for increasing sales by inducing the customer to interact with a product that attracts their interest, even if that interest is minimal or transient. The method utilizes a display monitor placed close to a product that shows an informational presentation on the product, but only when activated by a customer. The presentation is activated when a customer touches the display. The monitor and activation means are placed close to the product, rather than elsewhere in the store, sufficiently close that a customer located within viewing distance and within touching distance of the product can also reach out and activate the presentation without taking a step. The display is placed at a convenient height for easy viewing, and so that the customer may touch and examine the product while viewing and listening to the presentation.

The apparatus for accomplishing this method meets engineering and functional requirements associated with deployment in a store where many products compete for space. The apparatus is compact, preferably uses an electrical battery for power and is optimized to reduce its power consumption to a low level.

### REFERENCES CITED

### US Patent Documents

| Patent No. | Issue Date | Inventors |
|---|---|---|
| 7,159,771 | January 2007 | Khairil Singgih, et al |
| 6,899,311 | May 2005 | John P. Ternus |
| 6,587,835 | January 2003 | G. Victor Treyz, et al. |
| 5,979,757 | November 1999 | William X. Tracy et al |
| 5,463,209 | October 1995 | Jack Figh, et al |

### Other Publications

Why We Buy: The Science of Shopping, Paco Underhill, Simon and Schuster Paperbacks, Rockefeller Center, 1230 Avenue of the Americas, New York, N.Y. 10020, (1999), ISBN 0-684-84914-3
Winning at Retail, Willard N. Ander and Neil Z. Stern, John Wiley & Sons, Inc, New Jersey, (2004), ISBN 0-471-47357-X
Retail Success, George Whalin, Willoughby Press, 1635 S. Rancho Santa Fe Road, Suite 206, San Marcos, Calif. 92069 (2001), ISBN 0-9706435-0-0

### FIELD OF THE INVENTION

The field of the invention is retail sales.

### BACKGROUND OF THE INVENTION

Retail sales has changed drastically since the early 1980s with the advent of “Big Box” stores such as Wal-Mart and The Home Depot. These stores have provided products in a huge store (shaped like a big box) characterized by low numbers of unknowledgeable sales people, high numbers of items and the lowest retail prices. The Home Depot has over 2000 stores in the US with over 50,000 SKUs (SKUs are Shelf Keeping Units and represent individual purchasable items) and offers “everyday low prices” (everyday low prices means an emphasis on lowest prices available at all times in the region rather than putting items on sale to attract buyers). Over 2,500,000 people walk through The Home Depot stores every day. Wal-Mart is even larger.

Sales people in these Big Box stores are mainly hired to keep product on the shelves and are not knowledgeable about the products nor do they have the time to provide product knowledge help to consumers.

A “rule of thumb” applied to these Big Box stores is that the consumer must understand and be able to make a buying decision on an individual SKU within four seconds. Many products do not meet this criterion. As a result the store may not carry the item. If it does carry the item that cannot be understood by the consumer in a few seconds, it will probably sell poorly. To improve sales, suppliers offer signage, graphics on the packaging, advertising in the media, web site information, brochures, and in a very few cases, kiosks are installed in the stores. All of these methods and devices fail to satisfy the need of the vast majority of products. Advertising is very expensive and uneconomical given the low margins required to sell to the Big Boxes. Signage space is limited and the sales people in a store may choose not put it up. Packaging and graphics are strictly controlled by the Big Box stores so only a limited amount of information can be provided. Hiring demonstrators to work in each store is very expensive.

These same considerations apply to the smaller retailers who compete with the Big Boxes. The smaller retailers are under great price pressure so their most common competitive response is to provide a higher level of service and customer support. However, this further increases their costs. The smaller retailers need to lower their costs while still providing high levels of education to their customers.

A leading expert and pioneer on consumer behavior, Paco Underhill, author of Why We Buy, has shown that customers buy more products when they are “intercepted” by sales people. The Big Box stores have very low interception rates so sales need to be increased by other means. Underhill has also shown that sales are increased when customers touch a product. Packaging has evolved in recent years to allow customers to touch, feel or manipulate more of the products previously packaged in “clamshells”, (a plastic encasement for the product, usually also containing signage describing the product.) However, if the product is too complex or difficult to understand, even these added “touches” will not increase sales.

There is generally a need to connect the product with a prospective customer very quickly in order for the customer to make a purchase. Displays and signage must command the customer's attention and communicate what the product is and does, how it is used, and its price, so that the customer is very clear that the product will be a worthwhile purchase. For some products whose use is more complex, the product information cannot be communicated quickly using passive displays or signage. The customer may feel the product is too complicated. For such products the customer is likely to pass by without purchasing. The unmet need is a means to hold the customer's attention and explain a product's use so the customer feels that they understand the product sufficiently to make a purchase.

Previous means to educate customers include help from a store clerk, passive displays, and instruction manuals that are provided with the product. Space around products is at a premium, so the education means must take up a minimal amount of store space.

Previous means of merchandising products whose use is not obvious to the average customer have not been effective. There exists a need to communicate effectively with the customer while the customer's attention is first on the product. The present invention provides a portable, self-contained and effective means of communicating and teaching a customer about a product when the customer's attention is focused on the product, and in the immediate location of the product.

### SUMMARY OF THE INVENTION

The invention is both a method and an apparatus.

The method is to teach or educate a customer about a product, at the location and time that a customer is first attracted to the product. While in the close vicinity of a product, the customer is invited to activate a POP or monitor using a push button or a touch screen. A POD “point of purchase” or “point of display” may be at the checkout, in an aisle, on a shelf, or on a peg. More properly the term means “in the same location as the SKU”. The POP monitor displays an “Infomercial” (short audio/video presentation that explains how to use the product). Preferably the customer can touch the product while this teaching occurs. The method includes appropriate placement of the POP monitor, appropriate format and duration for the teaching presentation, and a simple activation means. The apparatus is both portable and self contained, not requiring connection to any other means if battery powered.

### PRIOR ART

### (a) Products

Monitors for use a sales environment are currently available as found in web sites listed below:

http://www.millertech.com/digital_signage/digital_signs.htm
http://www.visualeyes.com/services/pointof_p.html
http://www.visualeyes.com/services/inter_kiosk.html
http://www.scala.com/words/what/point-of-purchase-displays.html
http://www.globalspec.com/Industrial-Directory/point_of_purchase_display

An article on POP displays in hardware stores is referenced below:

http://findarticles.com/p/articles/mi_m0VCW/is_{—}15_{—}27/ai_{—}78236965

However these monitors do not fill the unmet need described above. They are monitors that can display infomercials but have one of more of the following flaws: they are not integrated with the SKU being sold, are not as mobile as the SKUs being sold, are too large and inconvenient, are not self-contained in a small footprint, and are not designed to have the attracted customer touch the screen or actuator button to receive the suitably brief infomercial.

### (b) Prior Art Patents

### Abstract of Treyz Patent

A system is provided in which a handheld computing device may be used to provide a user with shopping assistance services. A shopping assistance service may allow a user to obtain directory information for a shopping mall. A user may use the handheld computing device to handle shopping lists. The handheld computing device may display promotional material based on the shopping lists. The handheld computing device may be used to obtain information on products being sold in a store. Products may be purchased using wireless financial transactions. Reminders and other messages may be sent to the handheld computing device. The location of the handheld computing device may be monitored. Services may be provided to the user based on the location of the handheld computing device. The handheld computing device may communicate with communications equipment in retail establishments using a local wireless link.

Patent number: U.S. Pat. No. 6,587,835
Filing date: Feb. 9, 2000
Issue date: Jul. 1, 2003

### Inventors: G. Victor Treyz, Susan M. Treyz

### Primary Examiner: Donald L. Champagne

### Abstract of Tracy Patent

The present invention relates to an improved portable shopping system. The system is provided with improved data presentation system for presenting customer desired data on a portable terminal. The portable terminal includes audio as well as video presentation means which are used to provide customer specific marketing files to promote the sale of identified items.

Patent number: U.S. Pat. No. 5,979,757
Filing date: Dec. 20, 1996
Issue date: Nov. 9, 1999

### Inventors: William X. Tracy, Thomas K. Roslak, Judith Murrah, Francis Riso, Robert Beach, Robert Sandler, John Klein

### Assignee: Symbol Technologies, Inc.

### Primary Examiner: Douglas X. Rodriguez

### Abstract of Figh Patent

An arrangement for providing any customer present at a vending location at which a group of products is offered for sale with information about any member of such group includes an audiovisual device and a customer-initiated request entry device both situated at the vending location. Data representative of audiovisual information segments pertaining to the individual products of the group are stored in separate portions of a data storage medium and are retrieved from there and used to drive the audiovisual device to present the segment that corresponds to the request. When the products have optically distinguishable markings that uniquely identify them by product type associated therewith, the entering means may include an optical scanner arranged in such a manner as to enable any customer to bring a chosen marking and the optical scanner in relative positions in which the optical scanner scans the chosen marking and generates the addressing signal.

Patent number: U.S. Pat. No. 5,463,209
Filing date: Feb. 3, 1995
Issue date: Oct. 31, 1995

### Inventors: Jack Figh, Robert V. Cuddihy, Jr.

### Assignee: HMG Worldwide In-Store Marketing, Inc.

### Abstract of Singgih Patent

An information kiosk is disclosed. The information kiosk preferably has a touch-screen LCD display for convenient user interface. The information kiosk has an adjustable support stand for supporting the kiosk for convenient viewing by its users. The support stand also has a nested extension leg, which can be pulled out from stowage within the support stand. The extension leg, when pulled out and locked to the support stand, extends the length of the support stand, thus providing different viewing angles for the kiosk users with different heights, while maintaining the same angle between the support stand and the display head. The hinge, between which the hinge and the display body is connected, has a tension-based movement to prevent the kiosk from unintentional collapse. Ventilation openings are implemented on the upper back side of the kiosk. A barcode scanner is preferably integrally positioned to the top of the LCD display.

Patent number: U.S. Pat. No. 7,159,771
Filing date: Nov. 30, 2004
Issue date: Jan. 9, 2007

### Inventors: Khairil Singgih, See Hing Tiang

### Assignee: Pioneer Pos Inc.

### Primary Examiner: Michael G. Lee

### Secondary Examiner: Kristy A. Haupt

### Attorneys: East IP Group, Philip K. Yu

### Abstract of Ternus Patent

A display arrangement is disclosed. The display arrangement includes a flat panel display. The display arrangement further includes a display housing for the flat panel display. The display arrangement also includes an adjustable leg for supporting the display housing and thus the flat panel display in an inclined position. The display arrangement additionally includes a hinge for coupling the adjustable leg to the display housing so that the adjustable leg is pivotable relative to the display housing. The hinge is configured to provide a tilting action for adjusting the tilt angle of the display arrangement, and a collapsing action for reducing the depth of the display arrangement.

Patent number: U.S. Pat. No. 6,899,311
Filing date: Jan. 22, 2003
Issue date: May 31, 2005

### Inventor: John P. Ternus

### Assignee: Apple Computer, Inc.

### Primary Examiner: Ramon O Ramirez

### Attorney: Beyer Weaver & Thomas, LLP

None of these patents describe inventions that include all the salient features of the invention disclosed herein.

### BRIEF DESCRIPTION OF THE DRAWINGS

FIG. 1: A schematic layout of an apparatus designed to accomplish the goals of the sales method

FIG. 2: A schematic showing the potential locations of the power supply to the apparatus.

FIG. 3: Mounting of the apparatus on a pole

FIG. 4: Mounting of the apparatus on a pole, with external power supply.

FIG. 4a: Schematic of battery placement.

FIG. 5: Mounting of the apparatus on a shelf or flat area

FIG. 6: Mounting of the apparatus by hanging from a peg

### DETAILED DESCRIPTION OF THE INVENTION AND PREFERRED EMBODIMENTS

The method and apparatus of this invention causes the customer to handle the SKU and understand its operation and application. The information on the SKU includes the web site where the infomercial seen on the POP mini-kiosk can be viewed and downloaded remotely. The usual information on the SKU packaging is otherwise unchanged.

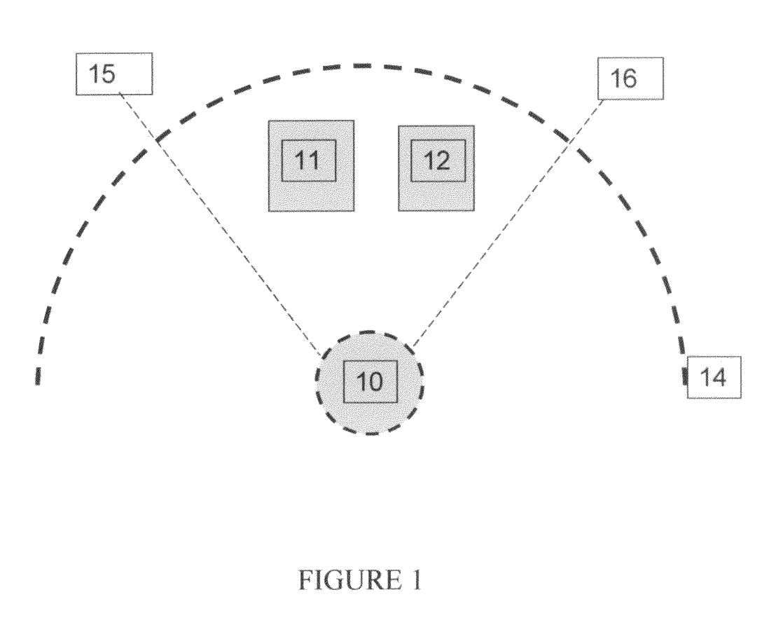

The apparatus includes means necessary to make the presentation. Referring to FIG. 1, it has a monitor 100, and a means by which the customer can activate it 103, thus starting an audio/video presentation. This activation means 103 might be a push-button or ideally a touch screen. The audio/visual material presented is stored on a medium 110 that is a flash card or flash drive such as SanDisk Cruzer® Profile USB Flash Drive which is secure, but removable by the merchandiser. The POP monitor includes a means for providing electrical power, 113. The POP monitor includes a means for mounting it which might be a means of attaching it to the product itself, a means such as a pole or stand to hold it at eye-level very close to the product, or a means of attaching it to the product display shelving itself, such as using pegs in a peg-board. The placement of the monitor is a key element of this invention; it must be placed either on the product, or in a location very close to the product. The physical attributes of the POP monitor apparatus enable appropriate positioning according to the teachings of the method.

The POP monitor may be powered by replaceable batteries, or using 120V A/C, or 12 VDC or some other means. All such means are included in the invention.

The POP monitor is ideally small enough to be attached to the product itself, or placed on or hung from the product display shelving. It must be sized to take up a minimum of space near the product, small enough to require the viewer to step close to it, yet large enough to be readable within arm's reach. The format of the presented material is ideally well-suited to viewing at arm's length or closer. A brief flash of an image might be used to attract a customer passing the SKU location.

### Method:

The method disclosed herein is a technique and practice for improving sales in a retail environment. The method involves presenting a customer with useful information while the customer is touching the product at the display location. The method involves placing a POP monitor either on or close enough to touch the POP monitor at the same time as the product, inviting a customer to activate the presentation, and providing a presentation on the product as a type of infomercial.

The presentation may be activated by a person assisting a customer, and still provide the advantages of direct customer activation.

In a variation on the method, the presentation may be activated by a store employee or other salesperson, in those cases where it would serve to assist in presenting information to the customer. In this mode, it may be useful to provide the option of pausing or muting the presentation so that a store employee or salesman can make specific points to the customer in a timely manner, without having to wait until the presentation is concluded, and then re-starting the presentation.

### Apparatus:

While any apparatus that meets the key features is included in the scope of this invention, there are several preferred embodiments for the POP monitor.

In the first embodiment, referring to FIG. 1, there is a small computer monitor screen 100, preferably 6.4″ diagonal in size with a resolution of 640×480 pixels. The monitor screen is preferably of the color LCD TFT type, and it preferably has a touch-screen capability. Screens of this type are well known, being similar in size, resolution and some functions similar to those found in cell-phones, GPS navigators, PDA's or high-end control systems. The screen monitor is enclosed in a package that also houses at least one computer chip 105, and a storage medium 110. The storage medium is preferably a flash card socket wherein a removable flash card containing the audio-visual presentation to be displayed is inserted. There is preferably a means of securing the flash card against unauthorized removal. The computer chip or chips together 105 carry out all the functions of the apparatus. The display is activated preferably by an activation means 103, which is preferably touch-screen activation, but it may be activated by a push button or proximity sensor. The power supply 113 to the package is preferably a set of standard rechargeable D-cell batteries mounted within the package. The entire apparatus is self-contained and includes a means of mounting it close to the product. The entire apparatus has a means of securing the flash card and batteries against unauthorized removal.

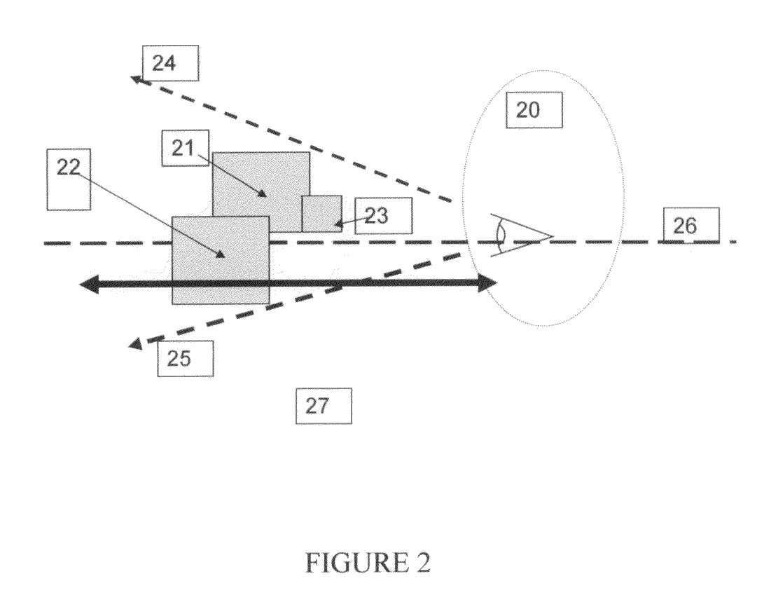

Referring now to FIG. 2, The screen 100 is preferably surrounded by a bezel 121, which may be integral to the package. The bezel allows the screen to be slightly recessed into the package. Recessing the screen provides some physical protection, and has an aesthetic aspect that encourages a customer to activate the display.

Preferably the package is attached to a sample of the product itself. Many products have large plastic clamshells that enclose the various product components. We envision attaching our POP monitor to the clamshell. The POP monitor is preferably not intended to be sold with the product but if it is attached to a product which is sold, it can easily be detached from the product by a simple tool before the product leaves the store. Such attachment and detachment means are included in this invention. Preferably such detachment is carried out at a check-out stand if the customer buys the product with the display attached. The package preferably has a weight and size consistent with mounting on the package. We generally envision a weight not more than about 5 lbs (five pounds, or 11.0 Kilograms), and a size not more than about 8″×5″×2.5″ (not including the battery or power source), depending on the actual embodiment used. The size and weight for each of the various embodiments may be considerably less than these values.

There is preferably a means of directing a customer's attention to the POP monitor, such as arranging for the screen to flash a message periodically or by a proximity sensor. The customer may also be drawn to the device by closely proximate advertising signage such as “touch this screen for useful information on . . . ” to draw the customer's attention to the screen and encourage him or her to activate it.

The POP monitor is preferably activated by touching the screen, but may also be activated by a push button. On activation, the POP monitor preferably shows a short audio-visual presentation, preferably about 30 seconds in duration, which is then repeated preferably two more times. All presentation durations and number of repeats for the audio-visual presentation are included in this the scope of the invention. The presentation preferably directs the customer to the product packaging or a pamphlet located nearby for further information.

The POP monitor may include features such as Pause and Mute, so that a customer viewing the presentation can interact with the presentation. These features will allow the customer more time to compare the information in the presentation with the features of the product in real time, thus adding to the effectiveness of the presentation. These features also assist a store employee offering sales assistance to a customer while that customer is viewing the product.

The POP monitor is preferably mounted at a level and orientation to facilitate easy viewing by the customer.

We envision that the monitor and computer chip will draw about 600 milli-amperes of electrical current at a voltage of 3V when the presentation is being displayed, and much less otherwise. Typical D-cell type batteries have a capacity of 20,000 milli-ampere-hours (mAhr), so that battery replacement will be required after at least about 10-20 hours of presentations, which is equivalent to between 400 and 800 90-second presentations. Preferably, the batteries will last about two weeks before replacement. We anticipate that rechargeable batteries will be the most cost-effective, rather than the standard alkali type. More D-cell batteries appropriately connected together, using methods well known in electrical engineering, provide even higher capacity, thus enabling a longer time between battery replacement.

There may be significant advantages to using an external power supply. Accordingly, referring still to FIG. 2, we envision a second embodiment where the power supply 114, which is internal to the POP monitor, may be replaced by an external power supply 115, which is placed close by but externally to the screen package, and connected to it by low voltage wiring. We envision the POP monitor placed close to the product, as disclosed in the second embodiment. The POP monitor now has two elements; a body and a power supply that together have at least the same functions as the first embodiment. The POP monitor body includes the monitor, chip and flash card socket, but the power supply is external to the package and supplies power through electrical wires and a connector. Such power supplies and electrical connections will be familiar to those skilled in that art. The wires and remote location are preferably unobtrusive and non-interfering with the other products in the display area. One advantage of a remote or external power supply is that its lifetime (in milli-Ampere-hours, (mAhr)) can be considerably longer than the lifetime of batteries that are contained in the POP monitor itself where size and weight are constrained. The external power supply is therefore an attractive alternative if more than about 1000 90-second presentations are expected between battery replacements.

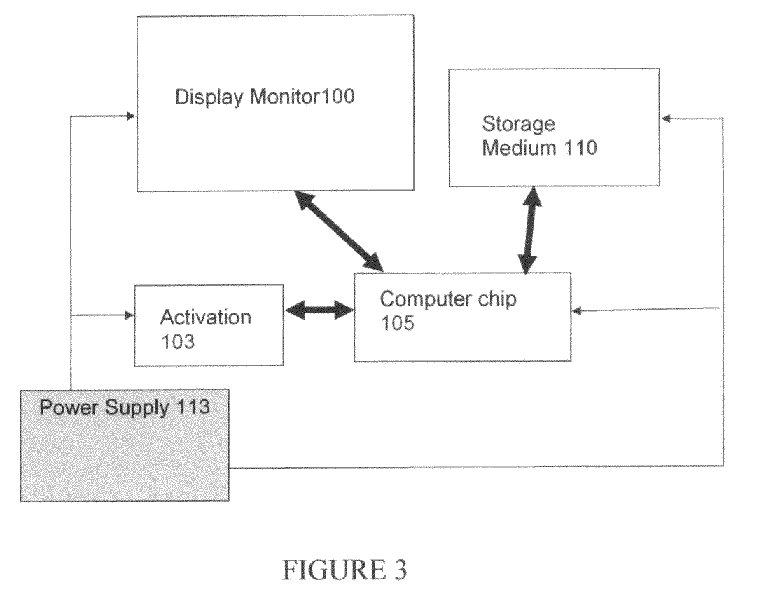

In a third embodiment, the POP monitor has the same physical elements, features and functions as those disclosed in the first embodiment, but the POP monitor is mounted on or in the display area, close to the product, for easy viewing, rather than being attached to the product itself. For example, referring to FIG. 3, the POP monitor body 201 is mounted atop a stand 204 whose base 205 contains the external power supply. The wires connecting the power supply 205 to the POP monitor body 201 run inside the riser 204. The screen 203 and the activation means 202 are placed close to the product and the entire unit would be placed in or on the display area so that the monitor is conveniently placed for easy viewing. By the phrase ‘close to the product’ we envision a placement such that a typical customer can examine the product and view the presentation easily without moving. We also envision that a customer can in fact touch both product and POP monitor easily without moving. This type of mounting would be ideal for products displayed in a dedicated stand containing a hole for the riser 204. The base would be hidden inside the stand, and the screen monitor would be placed close to the products, preferably for easy viewing.

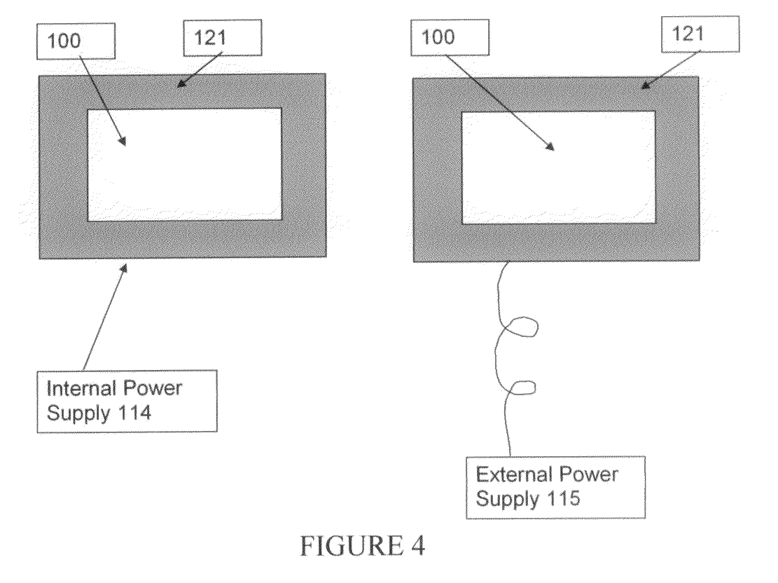

This embodiment may also be readily adapted to using an external power supply, as shown in FIG. 4, where 211 is the monitor body, 212 is the activation means, 213 is the screen, 214 is the riser, and 215 is the external power supply. The connecting wires run up through the riser 204 to the monitor body.

In a particularly interesting variation on this embodiment, the riser itself may house the power supply. For example, a set of D-cell batteries might simply be slid into the riser in the style of a powerful flashlight. The power supply capacity increased with the number of batteries, but in using multiple batteries, it will be important to obtain the correct voltage to drive the POP monitor. To obtain the ideal voltage, the batteries would be mounted on a frame with appropriate wiring so that the batteries act in electrical parallel. The frame and batteries are then slid into the riser. This is shown in FIG. 4(a), where the batteries 262 are mounted on the frame 261 containing wires 263. The frame 261 slides into the riser 204. The frame is secured with an end-cap 264. Not shown in FIG. 4(a) is the means whereby the wires 263 connect to the monitor body, as this is well within of standard engineering practice. The wiring is preferably such that pairs of D-cells are connected to the monitor in parallel. FIG. 4(a) shows ten batteries connected as five parallel pairs. This arrangement dramatically increases the replacement time of the battery pack. For example, a set of 10 D-Cells wired as six pairs, where each pair joined in parallel, has a capacity of 100,000 mAhr, which is five times larger than a single pair of D-cells (a single pair has a capacity of about 20,000 mAhr). This power supply would therefore be expected to provide about 5000 90-second presentations to customers. This embodiment may also be readily adapted to using an external power supply, as shown in FIG. 4, where 211 is the monitor body, 212 is the activation means, 213 is the screen, 214 is the riser, and 215 is the external power supply. The connecting wires run up through the riser 204 to the monitor body.

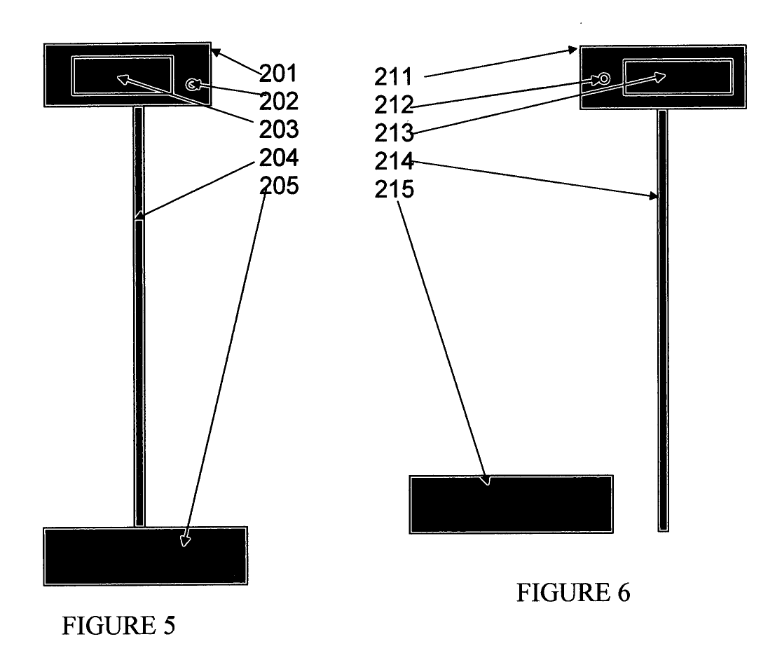

In a fourth embodiment, the POP monitor is placed on a shelf, close to the product. For example, it might be placed on a display shelf, close to the product, or even on top of a large product such as a refrigerator or bathroom cabinet. Referring to FIG. 5, which shows a side view of the POP monitor, 241 is the monitor body, 242 is the location of the screen (which is hidden from view at this angle) 243 is the battery pack and 244 is the flat surface on which the POP monitor is placed.

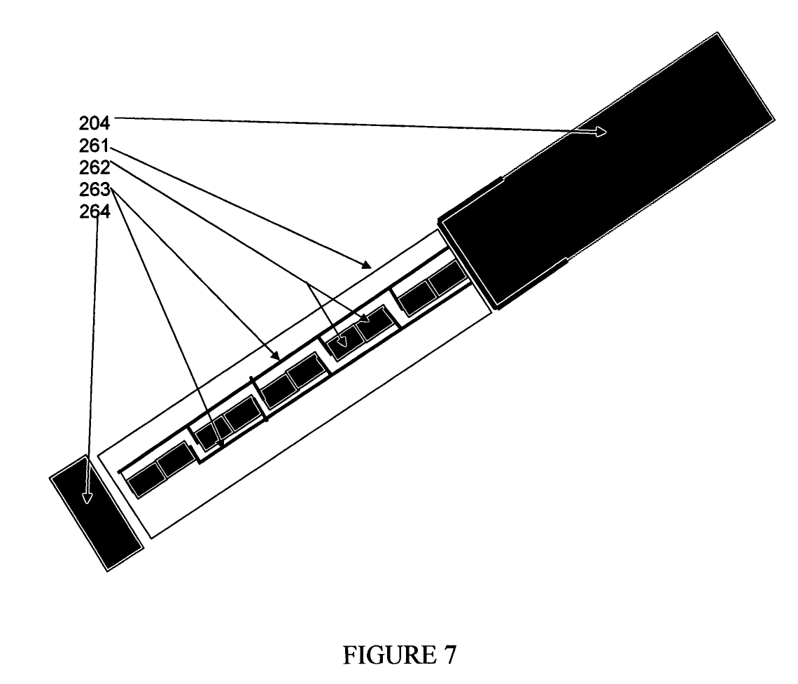

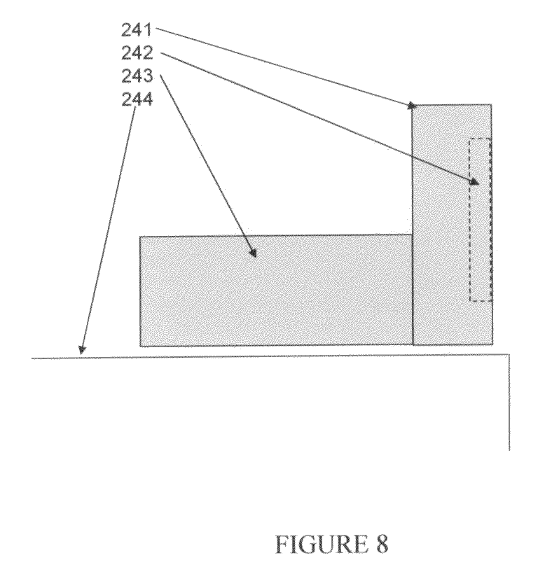

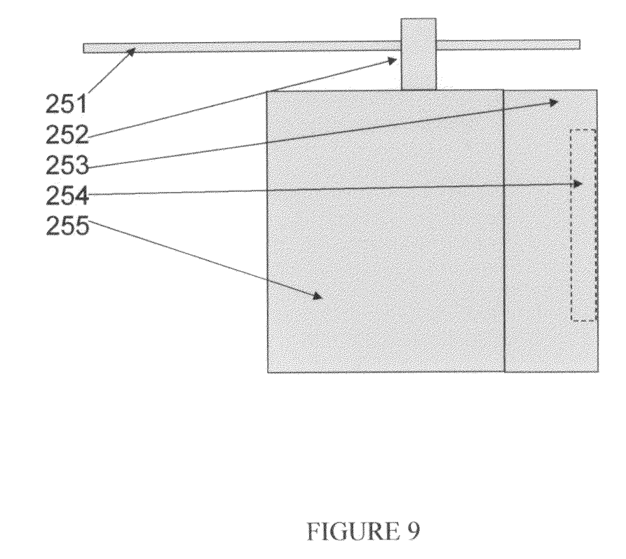

In a fifth embodiment, the POP monitor is hung from peg in a pegboard, as shown in FIG. 6. The peg 251 supports to POP monitor which is hung using a hook or holed support 252 which slips over the peg 251. The monitor body 253, and battery pack 255 are conjoined. In this embodiment the entire monitor takes up a location normally utilized for displaying a product, but can be placed immediately next to, or in close proximity to, products that are supported from neighboring pegs.

For embodiments that utilize and external power supply, the external power supply may be placed in close proximity to the POP monitor body, for example, by hanging on the same support peg but behind the POP monitor, or it may be placed some distance away from the SKU locations on the display area. One example of an external power supply location is the bottom of a display area, with wires running up the pegboard to the POP monitor body.

In yet another variation, an external power supply is a low voltage supply from a transformer connected to a local 120V A/C supply of the type common in households. Such transformers, low voltage lines and connectors will be familiar to those skilled in that art. In this instance the POP monitor body would have appropriate means of connecting to the low voltage supply.

In yet another variation, the storage medium is writable memory connected to an external port. That external port may be connected to a separate computer or storage medium through a connector, and the audio-visual presentation downloaded from the separate computer or storage medium to the POP monitor. The means for accomplishing this are well known to those skilled in that art and need not be described further here.

Several variations of this apparatus are envisioned to be within the scope of this invention. The presentation may be started by pushing a push button, such as is familiar from the computer ‘mouse’. In this case the LCD monitor would not need to be of the touch-screen type. Instead of a push button, there may be a touch button such as is familiar from microwave ovens. In short, any means of activation by the customer that performs the same function as a push button, touch screen, or touch button, in a similar mode of use, is deemed within the scope of this invention. Any type of monitor that is capable of displaying an audio-visual presentation, and that meets the other criteria such as ease of viewing and weight and size constraints, is also deemed to be within the scope of this invention. We envision monitors that may be smaller or larger, that employ technology other then LCD TFT, or that have a resolution different from 640×480, or a size different from 6.4″ diagonal, but otherwise meeting the requirements of the sales method described herein. Any power supply and cabling that is capable of driving any computer monitor or computer chip or chips that are part of the POP monitor apparatus is also deemed with the scope of this invention. Any type of parallel/series arrangement of batteries in a battery pack is deemed within the scope of this invention. Any means of mounting or supporting the POP monitor in a manner similar to those disclosed herein are also deemed within the scope of this invention. All presentation durations and number of repeats for the audio-visual presentation are included in this the scope of the invention.

In another variation, we envision that the presentation may be just video, rather than audio-visual together. The infomercial video can be of any style or format but ideally in .avi format. An example of an infomercial that could be used is can be found at:

http://www.amazon.com/Bosch-4000-07-10-Inch-Worksite-Folding/dp/B00005JDNM

The terms flash chip, thumb drive, LCD, and TFT, should be familiar to those skilled in the art of computer display and computer data storage and do not require further explanation here. A reference to a “product” usually means the product that is the subject of the POP monitor's display video.

Stores routinely carry out market research to provide a better shopping experience for the customer, and to increase sales. We envision that the POP monitor can be used to collect data on shopper behavior, such as a click counter to record each time that the display is activated. Such data can be correlated with the register tape, the number of shoppers in the store and the conversion rate to provide useful market research data to the store managers.

In a significant variation of the method described herein, the presentation may be used by a store employee to assist in providing information to a customer. In this mode of use, the presentation may be stopped and restarted by the employee.

Of the several embodiments herein described and their variations, the recommended best mode will depend on several factors associated with the product and the manner of its presentation to the customer. In general, since SKU space is highly valuable and low POP monitor maintenance is desirable, it will be desirable to use an embodiment that takes up the least amount of room, yet allows placement of the POP monitor close to the product, in an attractive manner. The options of shelf mounting, peg-board mounting and dedicated stand mounting, as well as any other mountings that are within the scope of this invention, the many possibilities for configuring the hardware, and the option of using an external power supply, give the practitioner great freedom of choice to optimize the POP monitor for the specific features of the product and its display parameters.

What is claimed is:

1. A method for communicating product information to a customer, wherein
(a) said information is included in an infomercial on said product
(b) said infomercial is presented on a portable self-contained display
(c) the presentation of said infomercial is activated by said customer
(d) said display and said product are in close proximity
(e) said display and said product are simultaneously located within a touching distance of said customer, and
(f) said display and said product are simultaneously located within an instantaneous field of view of said customer

2. The method of claim (1), wherein, on activation by said customer, the presentation of said infomercial is repeated one or more times and then stops.

3. The method of claim (1), wherein said display is placed at a convenient viewing location

4. The method of claim (1), wherein said display is less than 100 cm from said product.

5. The method of claim (1), wherein said display is associated to a facsimile of said product

6. The method of claim (1), wherein said display is associated to a display-only version of said product.

7. The method of claim (1), wherein the presentation is activated by a person other than the customer.

8. An apparatus for communicating information to a customer, comprising:
(a) a computer monitor capable of making an audio-visual presentation
(b) a means of storing computer data representing said audio-visual presentation on a computer-readable medium
(c) a means of reading said computer-readable medium
(d) a control means of having said computer monitor display said audio-visual presentation
(e) an activation means by which said customer may activate said presentation

9. The apparatus of claim 8, wherein the means of storing computer data representing said audio-visual presentation is a member of the group of flash chips, thumb drives, and hard-disk drives

10. The apparatus of claim 8, wherein the means by which said computer displays the infomercial includes at least one computer chip

11. The apparatus of claim 8, wherein the computer monitor is of the touch-screen type

12. The apparatus of claim 8, wherein said means by which said presentation is activated involves touching the screen of said display

13. The apparatus of claim 8, wherein the means by which said presentation is activated is involves pushing a button.

14. The apparatus of claim 8, wherein said apparatus includes a means of attaching apparatus to the product

15. The apparatus of claim 8, wherein said apparatus includes a means of hanging or fixing the apparatus in a display area, near said product

16. The apparatus of claim 8, wherein said apparatus includes a means of attaching said apparatus to a display-only version of said product

17. A method for communicating product information to a customer, wherein
(a) said information is made available on said product only by customer touch
(b) said infomercial is presented on a self-contained display of size and position so only optimally viewable and/or audible to one customer at a time
(c) and said product is also simultaneously located within a touching distance of said customer

18. A method for obtaining information about a customer interest in a particular product, wherein
(a) said product has a infomercial that must be activated by customer touch
(b) said activation is recorded by the display device

19. Said method in 18, wherein
(a) said information is transmitted in real time to sales associate to assist customer in making purchase
